(19) United States
(12) Patent Application Publication
(10) Pub. No.: US 2024/0421997 A1
(43) Pub. Date: Dec. 19, 2024

(54) MULTI-LEVEL FINGERPRINTS TO DERIVE MISSING DATA DURING RETRY DETECTION

(71) Applicant: VISA INTERNATIONAL SERVICE ASSOCIATION, SAN FRANCISCO, CA (US)

(72) Inventors: Ryan McCarter, Carrickergus (IE); Charles Catney, Belfast (IE); Hugh Mckillp, Drumbeg (IE)

(73) Assignee: VISA INTERNATIONAL SERVICE ASSOCIATION, SAN FRANCISCO, CA (US)

(21) Appl. No.: 18/728,063

(22) PCT Filed: Jan. 18, 2023
(86) PCT No.: PCT/US2023/060836

§ 371 Date: Jul. 10, 2024

Related U.S. Application Data
(60) Provisional application No. 63/304,432, filed on Jan. 28, 2022.

(51) Int. Cl. H04L 9/32; H04L 9/40

(52) U.S. Cl. CPC H04L 9/3213; H04L 9/3236; H04L 9/40

(57) ABSTRACT

A method performed by an access server is disclosed. The method including receiving a first access request including various fields of data for accessing a resource. The method may then generate a first fingerprint using a first value of a first field of the first access request and store the first fingerprint. After, the access server may receive a second access request, and generate a second fingerprint using a second value of the first field of the second access request. Then the first fingerprint can be compared to the second fingerprint to determine a possible match of the second access request to the first access request. A database is accessed using data of the first or second access request, to retrieve missing data in the first or second access request. The missing data can be compared to a corresponding field of the other access request to confirm a match.

### CROSS-REFERENCES TO RELATED APPLICATIONS

The present application claims priority from and is a PCT application of U.S. Provisional Application No. 63/304,432, entitled “Multi-Level Fingerprints To Derive Missing Data During Retry Detection” filed Jan. 28, 2022, the entire contents of which is herein incorporated by reference for all purposes.

### BACKGROUND

Consumer access requests conducted through a resource provider may make use of tokenized credentials. The resource provider may transmit the tokenized credential to a processing network (e.g., Visa) which may retrieve credentials associated with the tokenized credential that can be used to authorize the access request. After an outage or other failure in the processing network, impact analytics (which may contain a list of unique access requests that were impacted by the failure) may be difficult or time consuming to determine. For example, if the consumer/resource provider attempted and failed (due to system failure) to use their tokenized credential to complete an access request, the resource provider may prompt the consumer to enter their credentials manually to attempt the access request again. This results in two access requests logged by the processing network: one which contains a tokenized credential and another which contains credentials. These two different access requests may be difficult to link to each other.

Embodiments of the disclosure address this problem and other problems individually and collectively.

### SUMMARY

One embodiment of the invention includes a method. The method comprises: receiving, over a network, a first access request for accessing a resource, the first access request including various fields of data; generating a first fingerprint using a first value of a first field of the first access request; storing the first fingerprint; receiving a second access request; generating a second fingerprint using a second value of the first field of the second access request; comparing the first fingerprint to the second fingerprint to determine a possible match of the second access request to the first access request; accessing, using another fingerprint or value of another field of the first or second access request, a database to retrieve missing data in the first access request or the second access request, wherein the database stores fingerprints associated with other fields of data that is assigned by an access computer to facilitate access to resources; comparing the missing data to a corresponding field of the other access request to confirm a match.

An access server is disclosed. The access server comprising: a processor; and a non-transitory computer readable medium comprising instructions executable by the processor to perform operations including: receiving, over a network, a first access request for accessing a resource, the first access request including various fields of data; generating a first fingerprint using a first value of a first field of the first access request; storing the first fingerprint; receiving a second access request; generating a second fingerprint using a second value of the first field of the second access request; comparing the first fingerprint to the second fingerprint to determine a possible match of the second access request to the first access request; accessing, using another fingerprint or value of another field of the first or second access request, a database to retrieve missing data in the first access request or the second access request, wherein the database stores fingerprints associated with other fields of data that is assigned by an access computer to facilitate access to resources; comparing the missing data to a corresponding field of the other access request to confirm a match.

A better understanding of the nature and advantages of embodiments of the invention may be gained with reference to the following detailed description and accompanying drawings.

### BRIEF DESCRIPTION OF THE DRAWINGS

FIG. 1 shows a resource security system for authorizing access to resources, in accordance with some embodiments of the present invention.

FIG. 2 shows a block diagram of an access server communicating with a request computer, in accordance with some embodiments of the present invention.

FIG. 3 shows a block diagram of fingerprint databases, in accordance with some embodiments of the present invention.

FIG. 4 shows a block diagram of a fingerprint database used to detect retry access requests, in accordance with some embodiments of the present invention.

FIG. 5 shows a block diagram of an access server detecting retry access requests, in accordance with some embodiments of the present invention.

FIG. 6 shows a block diagram of an updated fingerprint database, in accordance with some embodiments of the present invention.

FIG. 7 shows a flowchart for using multi-level access request fingerprints to derive missing data during retry detection according to embodiments of the present invention.

FIG. 8 shows a block diagram of an exemplary computer apparatus, in accordance with some embodiments of the present invention.

### TERMS

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be a device that is operated by a user. Examples of user devices may include a mobile phone, a smart phone, a card, a personal digital assistant (PDA), a laptop computer, a desktop computer, a server computer, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. A user device may also be a credit, debit, or prepaid card.

The term “resource” generally refers to any asset that may be used or consumed. For example, the resource may be an electronic resource (e.g., stored data, received data, a computer account, a network-based account, an email inbox), a physical resource (e.g., a tangible object, a building, a safe, or a physical location), or other electronic communications between computers (e.g., a communication signal corresponding to an account for performing an access request). Thus, a physical resource can be a physical object.

The term “access request” (also referred to as an “authentication request”) generally refers to a request to access a resource. The access request may be received from a requesting computer, a user device, or a resource computer, for example. The access request may include authentication information (also referred to as authorization information), such as a user name, resource identifier, or password. The access request may also include and access request parameters, such as an access request identifier, a resource identifier, a timestamp, a date, a device or computer identifier, a geo-location, or any other suitable information. A real-time access request occurs when access to a resource is desired at the time the request is made. In such situations, it is desirable to provide a quick determination for whether to provide access to the resource.

The term “access result” generally refers to an outcome of an access request. The access result may be received from a resource computer or an access server. The access result may include all of the elements of the access request. For example, the access result may include authentication information (also referred to as authorization information), such as a user name, resource identifier, or password. The access result may also include access request parameters, such as an access request identifier, a resource identifier, a timestamp, a date, a device or computer identifier, a geo-location, or any other suitable information. In addition, the access result may include an evaluation score, or any suitable means of determination, for whether the access request was accepted (e.g., indicated by a positive evaluation score) or denied (e.g., indicated by a negative evaluation score). For example, if the access result includes a positive evaluation score or determination, the user is granted access to the resource. Similarly, if the access result includes a negative evaluation score or determination, the resource computer denies access to the resource.

The term “access result values” generally refers to possible outcomes of an access request (e.g., acceptances, rejections, fraud, and review). The set of outcomes determine whether or not access to the resource was granted to a user. The access result values can be counted to provide a set of counts of access results. As examples, the access result values can comprise a count for accepted access results, a count for rejected access results, a count for fraudulent access results, and a count for access results that need to be reviewed. The access result values may be included within historical access result data and used by a detector to generate a measure of approval for an access request.

A “token” may refer to a substitute identifier for some information. For example, an access request token may include an identifier for an access request account that is a substitute for an account identifier, such as a primary account number (PAN). For instance, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing access request processing networks (e.g., ISO 8583 financial transaction message format). In some embodiments, a token may be a random string of characters. In some embodiments, a token may be used in place of a PAN to initiate, authorize, settle, or resolve a access request. The token may also be used to represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” may refer to a process by which data is replaced with substitute data. For example, an account identifier (e.g., a primary account number (PAN)) may be tokenized by replacing the account identifier with a substitute number (e.g., a token) that is associated with the account identifier. Further, tokenization may be applied to other information which may be replaced with a substitute value. Tokenization may be used to enhance access request efficiency, improve access request security, increase service transparency, or to provide a method for third-party enablement.

A “fingerprint” may be a data structure that identifies at least part of an access request. In some examples, a fingerprint may normalize various data fields in an access request. Types of normalization can include removing spaces in the data field, changing case to all UPPER, changing case to all lower case, substitute special characters, etc. A fingerprint may be classified by the type of data that it stores. Fingerprints of a certain type may be standardized, for example, by normalizing the data, standardizing the set of data in an access request to store, standardizing the aggregation of the chosen data, hashing the data with a standardized hash used, etc. One example fingerprint may be an access request fingerprint that contains data related to an access request, such as a transaction amount, currency type, resource provider ID, etc. Another example fingerprint may be a credential fingerprint that contains data related to credential details of a user (PAI data), such as a (hashed) account number associated with the user (e.g., a credential such as a primary account number (PAN), a token formed by tokenizing the PAN, a credit card number, etc.). Yet another example fingerprint may be a reconciliation fingerprint that contains data related to reconciliation details of a user (PII data), such as the full name of the user (e.g., first name and last name), the billing address of the user, an email address associated with the user, etc. An access request fingerprint may be an example of a dynamic fingerprint, as the data stored by an access request fingerprint is generally unique to an access request. Both a reconciliation fingerprint and a credential fingerprint may be an example of a static fingerprint, as the data stored by them are generally unique to an account used to complete access requests (e.g., unique to a credit card used to complete access requests).

The term “server computer” may include a powerful computer or cluster of computers. For example, the server computer can be a large mainframe, a minicomputer cluster, or a group of computers functioning as a unit. In one example, the server computer may be a database server coupled to a web server. The server computer may be coupled to a database and may include any hardware, software, other logic, or combination of the preceding for servicing the requests from one or more other computers. The term “computer system” may generally refer to a system including one or more server computers coupled to one or more databases.

### DETAILED DESCRIPTION

Embodiments of the invention can provide for multi-level fingerprints that can be used to detect retry attempts of a user first attempting an access request using a credential, and subsequently using a tokenized credential (or tokenized then non-tokenized). A fingerprint can be generated by selecting a standardized set of data fields in an access request, normalizing those data fields, concatenating the data fields, and finally hashing to generate the fingerprint. Different types of fingerprints can be generated based on the set of data fields that are selected. Fingerprints that store generally static data of access requests can be stored by an access server, so that they may be used to derive missing data in future access requests. Dynamic fingerprints can be used to determine possible retry attempts, and may be used to retrieve the static fingerprints from the database to determine if the retry attempt matches.

Outages in an authentication system can cause access requests to fail as a result of errors. A failure may prompt a user to non-tokenized authentication information to retry the access request. A first step of determining a possible matches between access requests can performed by comparing access request fingerprints of the access requests. After determining possible matches, the token IDs of static fingerprints can be used to retrieve the static fingerprints themselves. Then, after all of the fingerprints for each of the possible matches are retrieved, they can be compared to determine if any of the access requests match.

### I. Authentication for Accessing a Protected Resource

A resource security system may receive requests to access a resource, such as an access requests for a computer resource or account (e.g., access requests over the Internet). The resource security system may include an access server for determining an outcome for the access request based on access rules. An exemplary resource security system is described in further detail below.

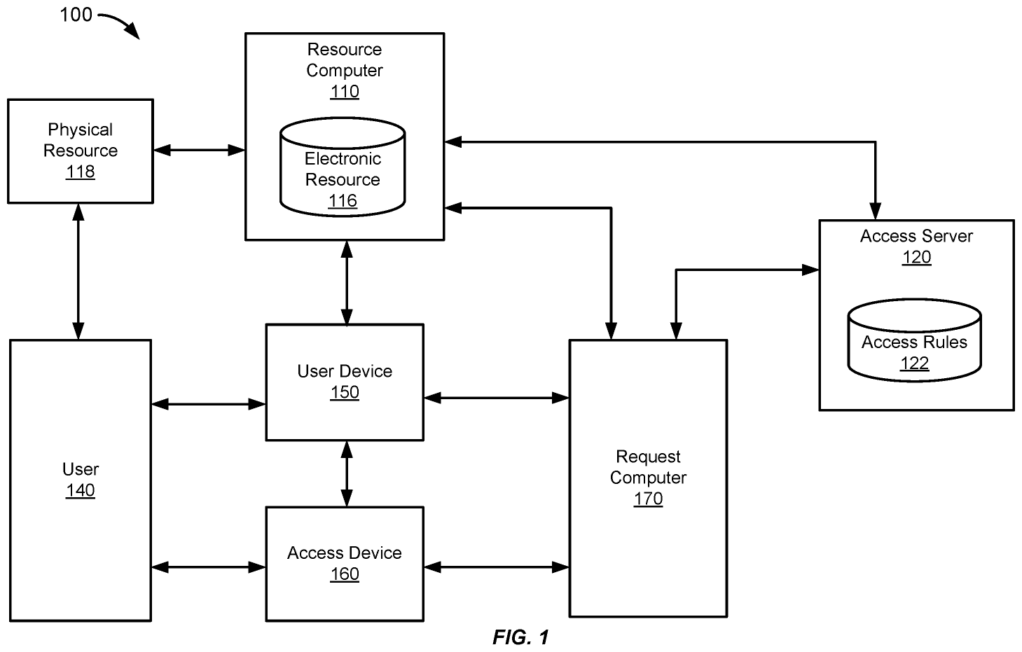

FIG. 1 shows a resource security system 100 for authorizing access to resources, in accordance with some embodiments. The resource security system 100 may be used to provide authorized users (e.g., via authentication) access to a resource while denying access to unauthorized users. In addition, the resource security system 100 may be used to deny fraudulent access requests that appear to be legitimate access requests of authorized users. The resource security system 100 may implement access rules to identify fraudulent access requests based on parameters of the access request. Such parameter may correspond to fields (nodes) of a data structure that is used to distinguish fraudulent access requests from authentic access requests.

The resource security system 100 includes a resource computer 110. The resource computer 110 may control access to a physical resource 118, such as a building, a lockbox, or goods, or an electronic resource 116, such as a local computer account, digital files or documents, a network database, an email inbox, a payment account, or a website login. In some embodiments, the resource computer may be a webserver, an email server, or a server of an account issuer. The resource computer 110 may receive an access request from a user 140 via a user device 150 (e.g., a computer or a mobile phone) of the user 140. The resource computer 110 may also receive the access request from the user 140 via a request computer 170 coupled with an access device 160 (e.g., a keypad or a terminal). In some embodiments, the request computer 170 may be a resource provider. For example, the request computer 170 and the resource computer 110 may be the same, wherein the access request from the user 140 is generated directly at the resource computer 110.

The access device 160 and the user device 150 may include a user input interface such as a keypad, a keyboard, a finger print reader, a retina scanner, any other type of biometric reader, a magnetic stripe reader, a chip card reader, a radio frequency identification reader, or a wireless or contactless communication interface, for example. The user 140 may input authentication information into the access device 160 or the user device 150 to access the resource. Authentication information may also be provided by the access device 160 and/or the user device 150. The authentication information may include, for example, one or more data elements of a user name, an account number (e.g., a primary account number (PAN), a credit card number, etc.), a token (e.g., a token formed by tokenizing a PAN), a password, a personal identification number, a signature, a digital certificate, an email address, a phone number, a physical address, and a network address. The data elements may be labeled as corresponding to a particular field (e.g., that a particular data element is an email address). In response to receiving authentication information input by the user 140, the user device 150 or the request computer 170 may send an access request, including authentication information, to the resource computer 110 along with one or more parameters of the access request.

In one example, the user 140 may enter one or more of an account number, a personal identification number, and password into the access device 160, to request access to a physical resource (e.g., to open a locked security door in order to access a building or a lockbox) and the request computer 170 may generate and send an access request to the resource computer 110 to request access to the resource. In another example, the user 140 may operate the user device 150 to request that the resource computer 110 provide access to the electronic resource 116 (e.g., a website or a file) that is hosted by the resource computer 110. In another example, the user device 150 may send an access request (e.g., an email) to the resource computer 110 (e.g., an email server) in order to provide data to the electronic resource 116 (e.g., deliver the email to an inbox). In another example, the user 140 may provide an account number and/or a personal identification number to an access device 160 in order to request access to a resource (e.g., a payment account) for conducting an access request. The authentication information in this example may include an account number (e.g., a credential such as a PAN or a hashed PAN), an amount (e.g., an amount required to conduct the access request), a currency type of the amount (e.g., USD, EUR, JPY, CNY, etc.), resource provider identifier (e.g., a resource provider ID number), full name of the user (e.g., first name and last name included), email address, an indication of if the access request was resource provider initiated vs user initiated access request, etc.

In some embodiments, the resource computer 110 may verify the authentication information of the access request based on information stored at the request computer 170. In other embodiments, the request computer 170 may verify the authentication information of the access request based on information stored at the resource computer 110.

The resource computer 110 may receive the request substantially in real-time (e.g., account for delays computer processing and electronic communication). Once the access request is received, the resource computer 110 may determine parameters of the access request. In some embodiments, the parameters may be provided by the user device 150 or the request computer 170. For example, the parameters may include one or more of: a time that the access request was received, a day of the week that the access request was received, the source-location of the access request, the amount of resources requested, an identifier of the resource being request, an identifier of the user 140, the access device 160, the user device 150, the request computer 170, a location of the user 140, the access device 160, the user device 150, the request computer 170, an indication of when, where, or how the access request is received by the resource computer 110, an indication of when, where, or how the access request is sent by the user 140 or the user device 150, an indication of the requested use of the electronic resource 116 or the physical resource 118, and an indication of the type, status, amount, or form of the resource being requested. In other embodiments, the request computer 170 or the access server 120 may determine the parameters of the access request.

The resource computer 110 or the request computer 170 may send the parameters of the access request to the access server 120 in order to determine whether the access request is fraudulent. The access server 120 may store one or more access rules 122 for identifying a fraudulent access request. Each of the access rules 122 may include one or more conditions corresponding to one or more parameters of the access request. The access server 120 may determine an access request outcome indicating whether the access request should be accepted (e.g., access to the resource granted), rejected (e.g., access to the resource denied), or reviewed by comparing the access rules 122 to the parameters of the access request as further described below. In some embodiments, instead of determining an access request outcome, the access server 120 may determine an evaluation score based on outcomes of the access rules. The evaluation score may indicate the risk or likelihood of the access require being fraudulent. If the evaluation score indicates that the access request is likely to be fraudulent, then the access server 120 may reject the access request.

The access server 120 may send the indication of the access request outcome to the resource computer 110 (e.g., accept, reject, review, accept and review, or reject and review). In some embodiments, the access server 120 may send the evaluation score to the resource computer 110 instead. The resource computer 110 may then grant or deny access to the resource based on the indication of the access request outcome or based on the evaluation score. The resource computer 110 may also initiate a review process for the access request.

In some embodiments, the access server 120 may be remotely accessed by an administrator for configuration. The access server 120 may store data in a secure environment and implement user privileges and user role management for accessing different types of stored data. For example, user privileges may be set to enable users to perform one or more of the following operations: view logs of received access request, view logs of access request outcomes, enable or disable the execution of the access rules 122, update or modify the access rules 122, change certain access request outcomes. Different privileges may be set for different users.

The access server 120 may store access request information for each access requests that it receives. The access request information may include authentication information and/or the parameters of each of the access requests. The access request information may also include an indication of the access request outcome for the access request (e.g., whether access request was actually fraudulent or not). The access server 120 may also store validity information corresponding to each access request. The validity information for an access request may be initially based on its access request outcome. The validity information may be updated based on whether the access request is reported to be fraudulent. In some embodiments, the access server 120 or the request computer 170 may store the access request information and the validity information.

The access server 120 may generate one or more fingerprints for each access request that it receives. For example, in a payment access request, the access server 120 may generate an access request fingerprint such as (RESOURCEPROVIDERID∥CURRENCYTYPE∥AMOUNT∥ . . . ), a credential fingerprint such as (HASHEDACCOUNTNUMBER), and a reconciliation fingerprint such as (FIRSTNAME∥LASTNAME∥ADDRESS∥EMAIL∥ . . . ). For a specific account of the user 140, the credentials and the reconciliation details of the user 140 are generally static, and so the access server 120 may store the credential fingerprint and the reconciliation fingerprint in a database. Additionally, the access request fingerprint may be recorded (e.g., temporarily stored) in the database. The database can store fingerprints conducted by the user 140 with relation to a specific resource provider (e.g., the resource provider operating the request computer 170).

### II. Access Server

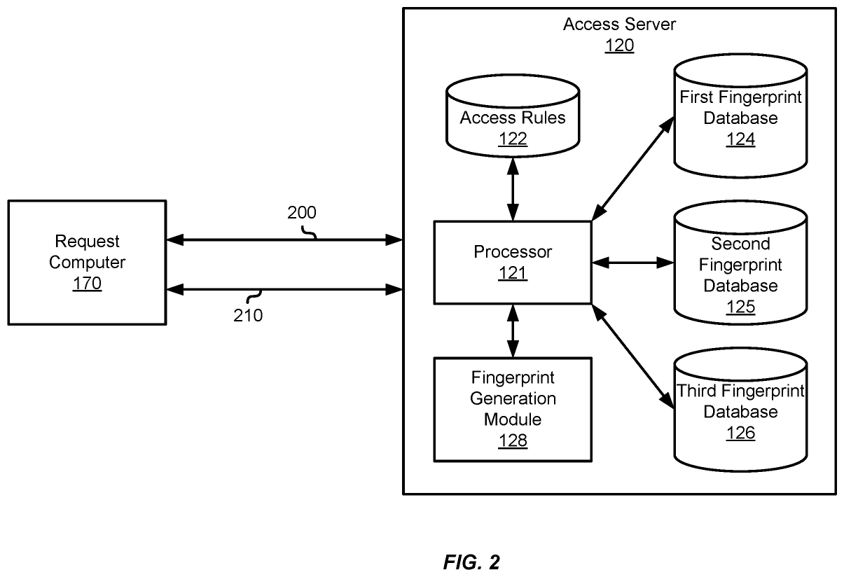

FIG. 2 shows a block diagram of an access server 120 communicating with a request computer 170, in accordance with some embodiments of the present invention. As described above, the access server 120 may perform access requests. The access server 120 may generate and store one or more fingerprints in one or more databases. For example, the access server 120 may format data received in an access request to generate an access request fingerprint (e.g., an access request fingerprint), a credential fingerprint, and a reconciliation fingerprint. The three different types of fingerprints may be stored in one or more databases, such as a first fingerprint database 124, a second fingerprint database 125, and a third fingerprint database 126. In this example, only three fingerprints are shown, however a different number of fingerprints can be generated for different types of access requests.

Fingerprints may be generated by the access server 120 using a fingerprint generation module 128. The fingerprint generation module 128 can generate a reconciliation fingerprint by normalizing data in an access request. For example, normalizing data in the access request can include removing spaces in the data field, changing case to all UPPER, changing case to all lower case, substitute special characters, etc. To complete the generation of the reconciliation fingerprint, the fingerprint generation module 128 can concatenate the data and tokenize the concatenated data. In some examples, a hash used by the fingerprint generation module 128 to tokenize the concatenated data may be the same hash used to create a hashed PAN included in the access request. Additional fingerprints, such as a credential fingerprint and a reconciliation fingerprint can be generated using the fingerprint generation module 128.

The access server 120 may communicate with the request computer 170 in a first access request 200. The processor 121 may determine the access server 120 received a reconciliation token ID, which refers to tokenized reconciliation data such as first name, a last name, an address, and an email in the access request. The access server 120 may attempt to de-tokenize the reconciliation data, however, an outage that causes the access server 120 to be unable to de-tokenize the data may occur. The outage may cause the first access request 200 to fail because the tokenized reconciliation data (or other tokenized data) could not be retrieved. The access server 120 may notify the request computer 170 that the first access request 200 resulted in an error.

After receiving notification that the first access request 200 failed, the request computer 170 may communicate with the access server 120 in a second access request 210. The second access request 210 may include the same data as the first access request 200, in a non-tokenized form. For example, if the first access request 200 included a reconciliation token ID that refers to tokenized reconciliation data, the second access request 210 may include the reconciliation data itself. The access server 120 may perform the steps described above to generate fingerprints with the data included in the second access request 210. After successfully generating a credential fingerprint, a reconciliation fingerprint, and an access request fingerprint, the access server 120 may complete the second access request 210.

The first access request 200 and the second access request 210 can relate to a same access request being performed. When performing analytics on all received access requests, the access server 120 would “double count” the one access request. As the first access request 200 contains a token ID which refers to tokenized data, and the second access request 210 contains raw data, it can be difficult to link the two access requests with one another.

### III. Fingerprint Databases

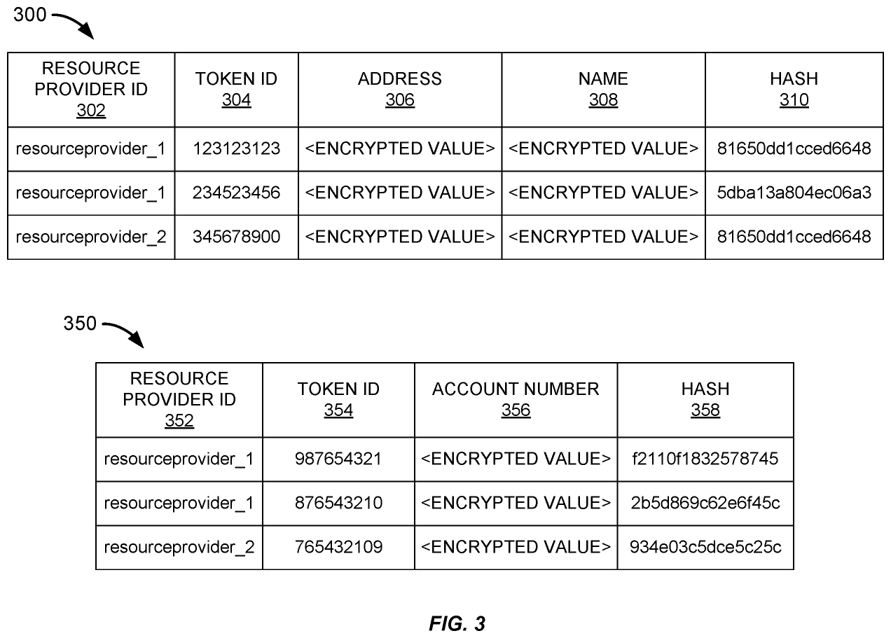

FIG. 3 shows a block diagram of fingerprint databases, in accordance with some embodiments of the present invention. As an example, the two fingerprint databases shown in FIG. 3 may correspond to a reconciliation database 300 and a credential database 350. The databases shown can be used to detect retry access requests. The two databases shown hold different types of fingerprints along with token IDs and raw (or encrypted) data. To detect a retry access request, either of the two databases may be accessed using the token ID, and can be used to retrieve a fingerprint. For example, the reconciliation token ID of the first access request 200 above can be used to access the reconciliation database 300 to retrieve the reconciliation fingerprint (e.g., shown in the hash 310 column) which can then be matched to the reconciliation fingerprint of the second access request 210.

### A. Reconciliation Fingerprint Database

An example reconciliation database 300 is shown in FIG. 3. The reconciliation database 300 comprises several fields of data. The data fields stored by the reconciliation database 300 include resource provider IDs 302, token IDs 304, addresses 306 (e.g., billing addresses), full name 308 (e.g., a combination of the first and last name), and hashes 310 (e.g., reconciliation fingerprints). The reconciliation database 300 stores billing addresses and the full name of the user 140, however different types of reconciliation data can be stored. The billing address and the full name of the user 140 may be encrypted to ensure the security of the user 140's data. There are three reconciliation fingerprints shown in the reconciliation database 300, which can be accessed using a reconciliation token ID. As an example, the user 140 may conduct two or more access requests with Resource provider 1 using a first credit card and a second credit card and may conduct one or more access requests with Resource provider 2 using a third credit card.

The first reconciliation fingerprint is stored in relation to Resource provider 1 and has a reconciliation token ID of 123123123. The first reconciliation fingerprint can store a first billing address of the user 140, and a first full name of the user 140. The reconciliation database may store the first reconciliation fingerprint (e.g., the hash of the concatenation of the first billing address and the first full name). The hash used to create the first reconciliation fingerprint, and other fingerprints in the application, may be SHA-256, MD-5, and the like. The second reconciliation fingerprint is stored in relation to Resource provider 1 and has a reconciliation token ID of 234523456. The second reconciliation fingerprint can store a second billing address of the user 140, and a second full name of the user 140. The reconciliation database may store the second reconciliation fingerprint (e.g., the hash of the concatenation of the second billing address and the second full name). The third reconciliation fingerprint is stored in relation to Resource provider 2 and has a reconciliation token ID of 345678900. The reconciliation database may store the third reconciliation fingerprint (e.g., the hash of the concatenation of the third billing address and the third full name). The third reconciliation fingerprint can store a third billing address of the user 140, and a third full name of the user 140. In this example, the third billing address of the user 140 and the third full name of the user 140 are the same as the first billing address of the user 140 and the first full name of the user 140 (e.g., the billing address and full name associated with the first credit card and the third credit card are the same, or the first credit card and the third credit card themselves are the same). Thus, the third reconciliation fingerprint and the first reconciliation fingerprint may be the same.

### B. Credential Fingerprint Database

An example credential database 350 is shown in FIG. 3. The data fields stored by the credential database 350 include resource provider IDs 352, token IDs 354, account numbers 356 (e.g., credit card numbers), and hashes 358 (e.g., credential fingerprints). The credential database 350 stores account numbers of the user 140, however different types of credential data can be stored. The credit card numbers of the user 140 may be encrypted to ensure the security of the user 140's data. There a three credential fingerprints shown in the credential database 350, which can be accessed using a credential token ID. As an example, the user 140 may conduct two or more access requests with Resource provider 1 using a first credit card and a second credit card and may conduct one or more access requests with Resource provider 2 using a third credit card.

The first credential fingerprint is stored in relation to Resource provider 1 and has a reconciliation token ID of 987654321. The first credential fingerprint can store a first account number (e.g., a first credit card number) of the user 140. The credential database may store the first credential fingerprint (e.g., the hash of the first account number). The second credential fingerprint is stored in relation to Resource provider 1 and has a reconciliation token ID of 876543210. The second credential fingerprint can store a second account number (e.g., a second credit card number) of the user 140. The credential database may store the second credential fingerprint (e.g., the hash of the second account number). The third credential fingerprint is stored in relation to Resource provider 2 and has a reconciliation token ID of 765432109. The third credential fingerprint can store a third account number (e.g., a third credit card number) of the user 140. The credential database may store the third credential fingerprint (e.g., the hash of the third account number).

### IV. Retry Detection

The collection of fingerprints and the fingerprint database may be used to detect repeat access requests. For example, when the access request outcome is “reject,” or if the access server 120 experienced an outage which caused the access request to time out, the user 140 may attempt a second access request. The user 140 may use the same or different authentication information in the second access request. In a payment access request, the first access request may have been conducted using a tokenized PAN and reconciliation data. To complete the first access request, the access server 120 may first need to de-tokenize the PAN and reconciliation data. However, due to some outage, the de-tokenization may fail which results in credential data and reconciliation data to be unable to be retrieved. The access server 120 may notify the user 140, or the request computer 170, of the failure (e.g., the access request outcome is equal to “error”) and may prompt the user 140 to conduct a second access request using the PAN and reconciliation data itself rather than the tokenized forms. As described above, the access server 120 may process the second access request, generating fingerprints using the authentication data, and complete the payment access request.

### A. Access Request Fingerprint Database

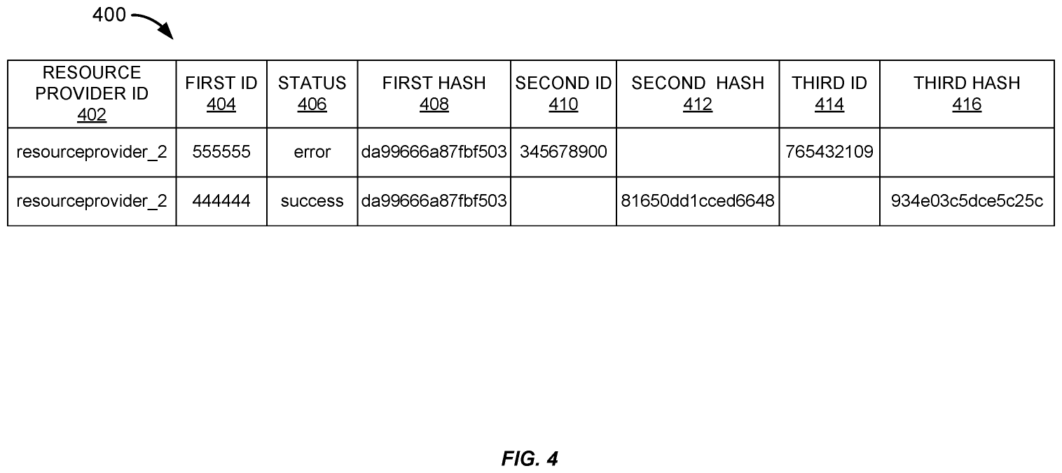

FIG. 4 shows a block diagram of a fingerprint database used to detect retry access requests, in accordance with some embodiments of the present invention. The fingerprint database may be an access request database 400. The access server 120 may store the data of access requests in the access request database 400. For example, data of the first access request 200 and the second access request 210 of FIG. 2 can be stored in the access request database 400. The data fields stored by the access request database 400 include resource provider ID 402, first ID 404, status 406, first hash 408, second ID 410, second hash 412, third ID 414, and third hash 416. The first hash 408 column may store access request fingerprints. An access request fingerprint for an access request can contain a hash of concatenated access request data (e.g., a access request amount, currency type, resource provider ID, etc.).

The access request database 400 stores each of the access request fingerprint (in the first hash 408 column), the reconciliation fingerprint (in the second hash 412 column), and the credential fingerprint (in the third hash 416 column) along with their associated access request token ID (in the first ID 404 column), reconciliation token ID (in the second ID 410 column), and credential token ID (in the third ID 414 column). The access request database 400 stores the complete access request data (e.g., the access request, reconciliation, and credential data) in reference to a resource provider ID and may also store the status of the access request (e.g., “error” or “success”). Two example access requests, which may be the first access request 200 and the second access request 210 of FIG. 2, are shown in the access request database 400. The first access request, identified by the access request token ID 555555, is conducted using a tokenized PAN that the access server 120 failed to de-tokenize, and as such, failed to retrieve reconciliation and credential data (e.g., a reconciliation fingerprint and a credential fingerprint) causing an “error.” The second access request, identified by the access request token ID 444444, is conducted using the PAN and reconciliation data. The access server 120 directly generates the reconciliation fingerprint and the credential fingerprint, and stores them upon receiving the second access request so they are included in the access request database.

### B. Deriving Missing Data Using Fingerprints

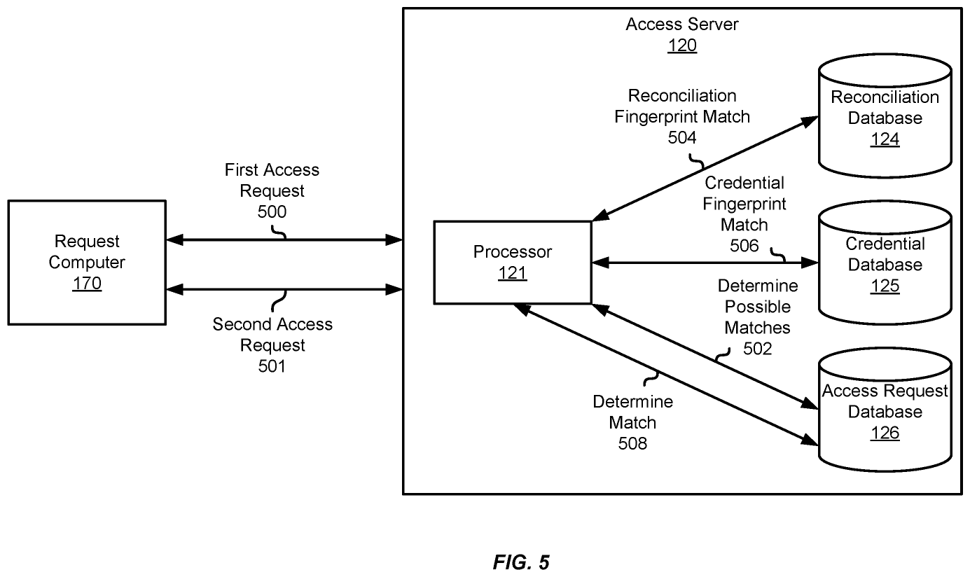

FIG. 5 shows a block diagram of an access server 120 detecting retry access requests, in accordance with some embodiments of the present invention. The access server 120 may perform analytics on access requests and may wish to determine the impact of the outage on received access requests. To do so, the access server 120 must link the first access request to the second access request. The first fingerprint database 124 may be a reconciliation database, the second fingerprint database 125 may be a credential database, and the third fingerprint database 126 may be access request database 400. The access request database 400 can be used to determine possible matches.

At step 500, the access server 120 may receive a first access request from a request computer 170 (e.g., as described by the first access request 200 of FIG. 2). For example, the first access request may receive access request data and the access server 120 generate an access request fingerprint, but fail to de-tokenize some data (e.g., reconciliation and credential data) received in the first access request. The status of the access request, as the data failed to de-tokenized may be set to “error.” The access server 129 may store the access requests fingerprint, the reconciliation token ID, the status, and the credential token ID in the access request database 400 (e.g., as shown by the access request 555555 of FIG. 4).

At step 501, after the first access request results in an error, the access server 120 may thereafter receive a second access request from the request computer 170 (e.g., as described by the second access request 210 of FIG. 2). The second access request may be performed using raw data, such as using a credit card number instead of a tokenized credit card number. The access server 120 can generate fingerprints (e.g., access request, reconciliation, and credential fingerprints) using the data of the second access request. The fingerprints of the second access request may be stored in the access request database, as shown by the access request 444444 of FIG. 4.

At step 502, to determine if any two access requests in the access request database 400 are a possible match, the access server 120 may compare stored access request fingerprints, specifically the first access request and the second access request. For example, the access server 120 may compare the first access request fingerprint to the second access request fingerprint shown in the access request database 400 of FIG. 4. As the two are equal, the access server 120 may determine the two access requests are a possible match.

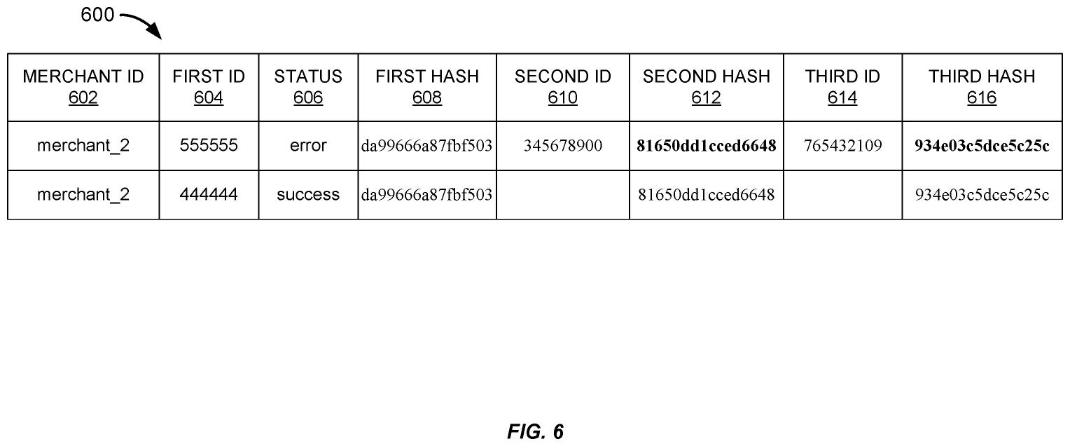

At step 504, after determining that the first access request is a possible match with the second access request, the access server 120 may access the first fingerprint database 124. The order of steps 502 and 504 are interchangeable, in other examples, step 504 may occur prior to step 502. The first fingerprint database 124 may be the reconciliation database 300 of FIG. 3. The access server 120 may retrieve the reconciliation token ID, 345678900, of the first access request from the access request database 400 and access the first fingerprint database 124 using the reconciliation token ID. The access server 120 may determine if any of the entries in the first fingerprint database 124 match the reconciliation token ID, and if found, the access server 120 may retrieve the reconciliation fingerprint associated with the reconciliation token ID (e.g., 81650dd1cced6648) and populate the access request database with the retrieved reconciliation fingerprint (as shown bold in the fingerprint database 600 of FIG. 6).

Similarly, at step 506, the access server 120 may retrieve the credential token ID, 765432109, of the first access request from the access request database 400 and access the second fingerprint database 125 using the credential token ID. The access server 120 may determine if any of the entries in the second fingerprint database 125 match the credential token ID, and if found, the access server 120 may retrieve the credential fingerprint associated with the credential token ID (e.g., 934e03c5dce5c25c) and populate the access request database 400 with the retrieved credential fingerprint (as shown in bold in the fingerprint database 600 of FIG. 6).

At step 508, the updated access request database 400 can now be used to detect retry access requests. The access server 120 may compare the fingerprints of the first access request to the fingerprints of the second access request. From the updated fingerprint database 600 of FIG. 6, it can be determined that the first access request and the second access request are a match as the values of the first hash 608 column, the second hash 612 column, and the third hash 616 column match (e.g., the access request fingerprints match, the reconciliation fingerprints match, and the credential fingerprints match).

Although the use of three types of fingerprints was discussed, a similar methodology performed using a different number of fingerprints. Static fingerprints (e.g., containing data that generally stays the same) can be stored in static databases, and dynamic fingerprints can be temporarily stored in dynamic databases (e.g., databases who periodically remove entries). As described above, the order in which the access server 120 accesses the databases to update the access request database 400 (or an equivalent database if more than three databases are used) can be different than described above. Additionally, although a scenario in which the final match is determined by matching fingerprints of two access requests, a similar process can be used in other scenarios. For example, the access server 120 may instead choose to populate the token IDs of both access requests and compare the token IDs of the two access requests to determine the final match. Another example scenario may include the hashing to generate fingerprints failing instead of de-tokenization failing. In such a scenario, the fingerprints of an access request in the access request database 400 would be missing and would be populated to detect retry access requests.

FIG. 6 shows a block diagram of an updated fingerprint database 600, in accordance with some embodiments of the present invention. The updated fingerprint database 600 may correspond to an updated access request database, where a reconciliation fingerprint (for the access request 555555 in the second hash 612 column) is populated using a reconciliation fingerprint retrieved from a reconciliation database and a credential fingerprint (for the access request 555555 in the third hash 616 column) is populated using a credential fingerprint retrieved from a credential database. The updated fingerprint database 600 contains missing data of the access request 555555. The missing data (e.g., the second hash and the third hash) can be used to easily determine, by a direct comparison of the fingerprints of the access requests, if the access request 444444 is a retry attempt of the access request 555555. As the access request 444444 was a retry attempt of the access request 555555, the two access requests are linked together such that they are not double counted in any access request analytics performed by the access server 120.

### V. Method

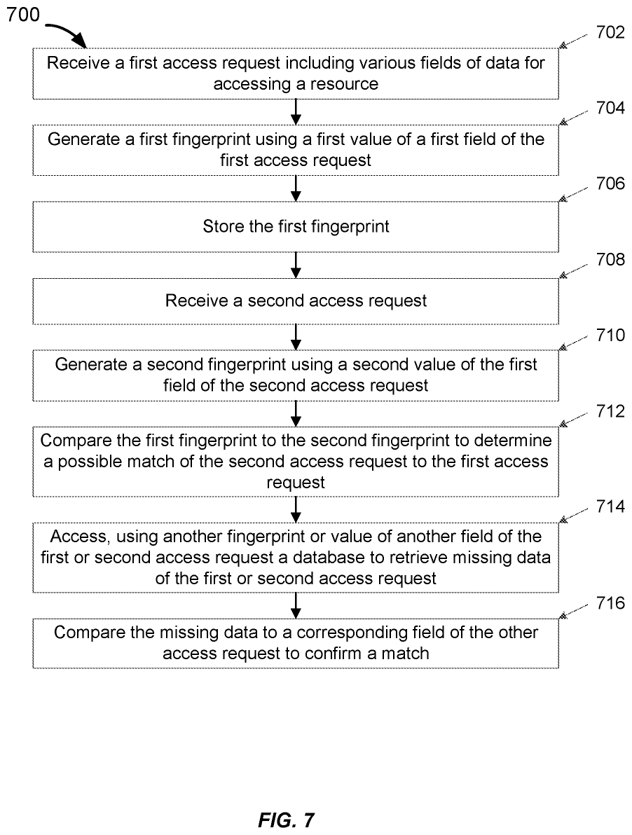

FIG. 7 shows a flowchart of a method 700 for using multi-level access request fingerprints to derive missing data during retry detection according to embodiments of the present invention. The method may be performed by a computer system, such as the access server 120 of FIG. 1.

At step 702, a first access request including various fields of data for accessing a resource can be received. The first access request may include access request information comprising authentication information, the parameters of each of the access requests, along with an indication of the access request outcome for the access request. The authentication information may comprise both static and dynamic data. Examples of static data may be reconciliation data (e.g., full name, billing address, email address, etc.) and credential data (e.g., a credential such as a PAN or credit card number, a tokenized credential, etc.). Examples of dynamic data may be access request data (e.g., a transaction amount, currency type, resource provider identifier).

At step 704, a first fingerprint can be generated. The first fingerprint may be generated using a first value of a first field of the first access request. For example, the first field may relate to access request data (e.g., amount). The first field may first be normalized, such as by standardizing the case, removing spaces, etc., and be subsequently hashed using a standardized hash (e.g., SHA-256, MD-5). The first fingerprint may therefore correspond to an access request fingerprint, which is a dynamic fingerprint. The first fingerprint may however include more than one field of the first access request. As an example, the amount, currency type, and resource provider identifier can be concatenated before being hashed. Other fingerprints may also be generated at this time, such as static fingerprints. A reconciliation fingerprint can correspond to other values in other fields of the first access request, and a credential fingerprint can correspond to yet other values in yet other fields of the first access request. The reconciliation fingerprint and the credential fingerprint can be generated in a similar manner to the first fingerprint.

At step 706, the first fingerprint can be stored. The first fingerprint can be stored in a database that stores fingerprints for received access requests. For example, the database can store access request fingerprints, reconciliation fingerprints, and credential fingerprints. In some examples, where the first fingerprint is an access request fingerprint, the database can be an access request database. The access request database can additionally store reconciliation fingerprints and reconciliation token identifiers, and credential fingerprints and credential token identifiers.

At step 708, a second access request including various fields of data for accessing a resource can be received. The second access request may include access request information similar to the first access request. If the first access request included a tokenized credential, the second access request can include a non-tokenized credential (or vice-versa).

At step 710, a second fingerprint can be generated. The second fingerprint can be generated using a second value of the first field of the second access request. If the first access request contains a tokenized credential and the second access request contains a non-tokenized credential, the second fingerprint can be generated by hashing the second value of the first field of the second access request using the same hash (e.g., a same hash function) that is used for tokenization of the credential.

At step 712, the first fingerprint may be compared to the second fingerprint to determine a possible match of the second access request to the first access request. The comparison may be done directly (e.g., bitwise). In some examples, the resource provider identifier in the first access request may first be compared to the resource provider identifier in the second access request. If the two resource provider identifiers do not match, the first access request and the second access request may be determined to not match. After determining a possible match, another fingerprint or value of another field of the first or second access request may be retrieved. For example, if the access request fingerprint of the first and second access requests match, the reconciliation token identifier (or the credential token identifier) can be retrieved from the access request database.

At step 714, a database can be accessed using the another fingerprint or value of another field of the first or second access request. The database can be searched for a match of the fingerprint or value of another field of the first or second access request. If a match is found, missing data of the first or second access request can be retrieved. For example, a reconciliation database can be searched using a reconciliation token identifier. If the reconciliation database contains a match to the reconciliation token identifier, a reconciliation fingerprint can be retrieved. The reconciliation fingerprint can be an example of missing data of the first or second access request. Afterwards, a similar type of search can be performed on the credential database using the credential token identifier.

At step 716, the missing data can be compared to a corresponding field of the other access request to confirm a match. For example, if the missing data is a reconciliation fingerprint in the first access request, the reconciliation fingerprint can be compared to the reconciliation fingerprint of the second access request. In some examples, the second access request may contain the reconciliation fingerprint itself (e.g., tokenized reconciliation data), in other examples reconciliation data may be included in one or more fields of the second access request, and may be required to be converted into a reconciliation fingerprint before comparing to determine a match.

### VI. Computer System

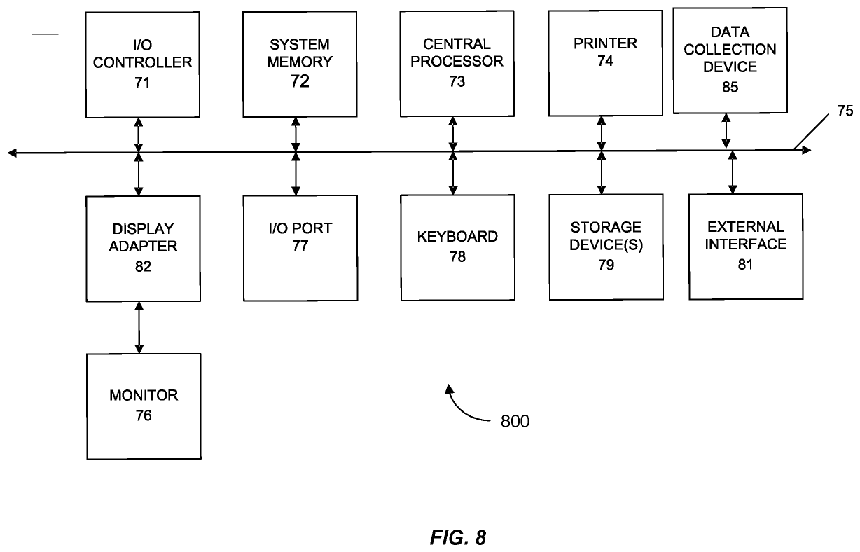

Any of the computer systems mentioned herein may utilize any suitable number of subsystems. Examples of such subsystems are shown in FIG. 8 in computer apparatus 800. In some embodiments, a computer system includes a single computer apparatus, where the subsystems can be components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 8 are interconnected via a system bus 75. Additional subsystems such as a printer 74, keyboard 78, storage device(s) 79, monitor 76, which is coupled to display adapter 82, and others are shown. Peripherals and input/output (I/O) devices, which couple to I/O controller 71, can be connected to the computer system by any number of means known in the art such as input/output (I/O) port 77 (e.g., USB, FireWire®). For example, I/O port 77 or external interface 81 (e.g. Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), as well as the exchange of information between subsystems. The system memory 72 and/or the storage device(s) 79 may embody a computer readable medium. Another subsystem is a data collection device 85, such as a camera, microphone, accelerometer, and the like. Any of the data mentioned herein can be output from one component to another component and can be output to the user.

A computer system can include a plurality of the same components or subsystems, e.g., connected together by external interface 81, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software with a generally programmable processor in a modular or integrated manner. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

1. A method comprising performing by an access computer:
receiving, over a network, a first access request for accessing a resource, the first access request including various fields of data;
generating a first fingerprint using a first value of a first field of the first access request;
storing the first fingerprint;
receiving a second access request;
generating a second fingerprint using a second value of the first field of the second access request;
comparing the first fingerprint to the second fingerprint to determine a possible match of the second access request to the first access request;
accessing, using another fingerprint or value of another field of the first or second access request, a database to retrieve missing data in the first access request or the second access request, wherein the database stores fingerprints associated with other fields of data that is assigned by the access computer to facilitate access to resources; and
comparing the missing data to a corresponding field of the other access request to confirm a match.

2. The method of claim 1, wherein the first fingerprint is a dynamic fingerprint.

3. The method of claim 1, wherein generating the first fingerprint further comprises:
normalizing the first value of the first field of the first access request; and
hashing the normalized first value of the first field of the first access request.

4. The method of claim 3, wherein the first fingerprint comprises values from more than one field of the first access request, and wherein generating the first fingerprint further comprises:
concatenating the values from the more than one field of the first access request.

5. The method of claim 1, wherein one of the first or second access request comprises a tokenized credential, and the other access request comprises a non-tokenized credential.

6. The method of claim 1, wherein the database stores static fingerprints associated with other fields of data that is assigned by the access computer to facilitate access to resources.

7. The method of claim 1, wherein the database stores data of the first access request and the second access request in reference to a resource provider identifier.

8. The method of claim 1, wherein the value of another field of the first or second access request used to access the database to retrieve missing data in the first access request or the second access request is a token identifier.

9. The method of claim 1, wherein the missing data is a static fingerprint.

10. The method of claim 1, further comprising:
before comparing the first fingerprint to the second fingerprint to determine the possible match of the second access request to the first access request:
comparing, a resource provider identifier in the first access request to a resource provider identifier in the second access request.

11. The method of claim 1, wherein the first access request comprises a tokenized credential, and the second access request comprises a non-tokenized credential, and wherein generating the second fingerprint comprises hashing the non-tokenized credential using a hash function that is used to tokenize the tokenized credential.

12. The method of claim 1, wherein the match is determined to be a retry attempt.

13. The method of claim 1, wherein the missing data in the first access request or the second access request is a first plurality of fingerprints, and wherein the corresponding field of the other access request is a second plurality of fingerprints.

14. The method of claim 1, wherein the resource is a physical resource.

15. (canceled)

16. An access server comprising:
a processor; and
a non-transitory computer readable medium comprising instructions executable by the processor to perform operations including:
receiving, over a network, a first access request for accessing a resource, the first access request including various fields of data;
generating a first fingerprint using a first value of a first field of the first access request;
storing the first fingerprint;
receiving a second access request;
generating a second fingerprint using a second value of the first field of the second access request;
comparing the first fingerprint to the second fingerprint to determine a possible match of the second access request to the first access request;
accessing, using another fingerprint or value of another field of the first or second access request, a database to retrieve missing data in the first access request or the second access request, wherein the database stores fingerprints associated with other fields of data that is assigned by an access computer to facilitate access to resources; and
comparing the missing data to a corresponding field of the other access request to confirm a match.

17. The access server of claim 16, wherein generating the first fingerprint further comprises:
normalizing the first value of the first field of the first access request; and
hashing the normalized first value of the first field of the first access request.

18. The access server of claim 16, wherein the first access request comprises a tokenized credential, and the second access request comprises a non-tokenized credential, and wherein generating the second fingerprint comprises hashing the non-tokenized credential using a hash function that is used to tokenize the tokenized credential.

19. The access server of claim 16, further comprising:
before comparing the first fingerprint to the second fingerprint to determine the possible match of the second access request to the first access request:
comparing, a resource provider identifier in the first access request to a resource provider identifier in the second access request.

20. The access server of claim 16, wherein the missing data in the first access request or the second access request is a first plurality of fingerprints, and wherein the corresponding field of the other access request is a second plurality of fingerprints.

21. The access server of claim 16, wherein one of the first or second access request comprises a tokenized credential, and the other access request comprises a non-tokenized credential.
